(19) United States
(12) Patent Application Publication
(10) Pub. No.: US 2009/0155926 A1
(43) Pub. Date: Jun. 18, 2009

(54) METHOD AND APPARATUS FOR DETECTING TRACE AMOUNTS OF SUBSTANCES

(76) Inventors: Yuval Ovadia, Kibbutz Yagur (IL); Yaniv Biran, Kiryat-Ono (IL)

Correspondence Address: Pearl Cohen Zedek Latzer, LLP, 1500 Broadway, 12th Floor, New York, NY, 10036, US

(21) Appl. No.: 12/089,162

(22) PCT Filed: Aug. 27, 2006
(86) PCT No.: PCT/IL06/00989

§ 371 Date: Jan. 5, 2009

(30) Foreign Application Priority Data
Sep. 6, 2005 (IL) 170701

(51) Int. Cl. G01N 1/02; B01J 19/00

(52) U.S. Cl. 436/177; 422/83

(57) ABSTRACT

A method and apparatus for detecting trace amounts of a target substance carried by the object, by: applying to the object a flow of air which has been pre-heated, to dislodge substances carried by the object; collecting the heated air after applied to the object; and analyzing the collected heated air for the presence of the target substance. Preferably, a marker substance is introduced into the air before applied to the objects, and the collected heated air is analyzed also for the presence of the marker substance.

### FIELD AND BACKGROUND OF THE INVENTION

The present invention relates to a method and apparatus for detecting trace amounts of substances. The invention is particularly useful for detecting concealed explosive substances or drug substances and is therefore described below with respect to such applications.

It is generally well recognized that there is a critical need for detecting concealed explosives and/or drugs in a manner which imposes a minimum intrusion or interference in routine practices for accommodating the movement of persons, luggage, and other objects. Many methods and systems have been proposed in the patent literature for accomplishing this purpose, as described for example in U.S. Pat. Nos. 4,819,477; 4,221,964; 5,104,513; 5,818,047; 5,942,699; 6,073,499; 6,074,608; and 6,794,645. Some of the disclosed methods are based on a sniffer technique wherein a flow of air is applied to the examined object in order to dislodge substances carried by the object, and then analyzing the collected air for the presence of the target substance, e.g. an explosive substance, a drug, or the like. Nevertheless, none of the known methods involving a sniffer technique has yet found widespread use, generally because of inadequate sensitivity, and therefore the examining techniques currently in use continue to be those based on a high degree of intrusion or interference with the movement of persons, luggage or other objects.

### OBJECTS AND BRIEF SUMMARY OF THE PRESENT INVENTION

An object of the present invention is to provide a method and apparatus for detecting trace amounts of substances in a manner which is capable of a high degree of sensitivity and which can be implemented with a minimum intrusion or interference in the movement of persons, luggage, and the like. Another object of the present invention is to provide such a method and apparatus which is particularly useful for detecting concealed explosives and/or drugs.

According to one aspect of the present invention there is provided a method of examining objects for detecting trace amounts of a target substance carried by the object, comprising: applying to the object a flow of air which has been preheated, to dislodge substances carried by the object; collecting the heated air after applied to the object; and analyzing the collected heated air for the presence of the target substance.

It will be seen that the above aspect of the method differs from conventional “sniffing” techniques, in that the air applied to the object in order to dislodge substances carried by the object is preheated before being applied to the object, e.g. a person, a piece of luggage, a container, or the like. Preferably, the air is pre-heated at least ten degrees Centigrade above ambient, but within the range of 20-42 degrees Centigrade. It has been found that when the air is so preheated before being applied to the object, the sensitivity of the “sniffing” technique is significantly increased. Also preferably, a marker substance is introduced into the air before applied to the object, and the collected heated air is analyzed also for the presence of the marker substance.

According to another aspect of the present invention, there is provided a method of examining objects within an examination station for detecting trace amounts of a target substance carried by the object, comprising: applying air both vertically and horizontally within the examination station to dislodge from the object substances carried by the object; collecting the air after applied to the object; and analyzing the collected air for the presence of the target substance.

According to further features in one described preferred embodiment, the examination station is of cylindrical configuration, and the heated air is applied both vertically through the examination station and horizontally within the examination station. It has been found that providing this feature also significantly increases the sensitivity of the method.

According to a further aspect of the present invention, there is provided apparatus for examining objects for detecting trace amounts of a target substance carried by the objects, comprising: a source of pressurized air for applying a flow of air to the object in order to dislodge substances therefrom; a heater for heating the air before applied to the object, a collector for collecting the air after applying it to the object; and an analyzer for analyzing the collected air for the presence said target substance.

According to yet a further aspect of the present invention there is provided apparatus for examining objects in order to detect trace amounts of a target substance carried by the objects comprising: an examination station sized and dimensioned for receiving the objects to be examined, a first group of nozzles for applying a flow of air vertically through the examination station in order to dislodge substances from the object; a second group of nozzles for applying a flow of air horizontally through the examination station in order to dislodge substances from the object; a collector for collecting the air after applied to the object; and an analyzer for analyzing the collected air for the presence of said target substance.

As will be described more particularly below, the foregoing features increase the sensitivity of the “sniffer” technique for detecting trace amounts of controlled substances with a minimum of intrusion or interference, such as to enable this technique to be effectively used for detecting concealed explosives and/or drugs. It will also be appreciated, however, that the invention could also be used in other methods and apparatus for detecting trace amounts of other substances, such as in analyzing the perspiration of a person for detecting various possible diseases, and in analyzing food products for food monitoring and control.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a block diagram broadly illustrating one feature of the present invention;

FIGS. 2a-2d illustrate one form of apparatus constructed in accordance with the present invention particularly for examining persons in order to detect trace amounts of a target substance, such as a concealed explosive or drug, and the various air-flow arrangements that may be provided in such an apparatus;

FIG. 3 illustrates a luggage inspection apparatus constructed in accordance with the present invention;

FIGS. 4a and 4b illustrate one form of manually transportable apparatus constructed in accordance with present invention;

FIG. 5 illustrates one form of apparatus constructed in accordance with the present invention carried by a wheeled cart to facilitate transporting it from one location to another;

FIG. 6 illustrates another apparatus constructed in accordance with the present invention particularly for examining large shipment containers in order to detect trace amounts of a targeted substance;

FIG. 7 illustrates another form of apparatus constructed in accordance with the present invention for examining containers for trace amounts of targeted substances;

FIG. 8 illustrates another form of apparatus constructed in accordance with the present invention and including a wireless transmitter for transmitting to a remote location the results of the examination; and

FIG. 9 illustrates an apparatus similar to that of FIG. 7, but modified to include an injector for introducing a marker substance into the air before applied to the object.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

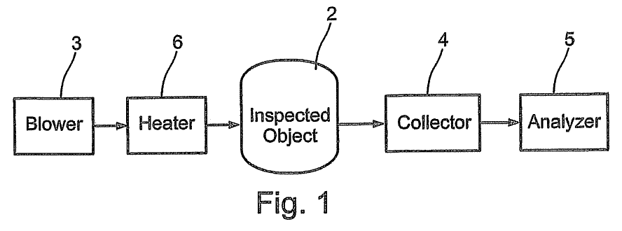

Reference is first made to the block diagram of FIG. 1 diagrammatically illustrating one form of apparatus constructed in accordance with the present invention. Thus, as shown in FIG. 1, the apparatus includes an examination station 2 for receiving the object to be examined, e.g. a person or a piece of luggage, in order to detect trace amounts of a target substance, such as a concealed explosive, drug, or the like. The illustrated apparatus further includes a blower 3 for applying to the object within examination station a flow of air in order to dislodge substance carried by the object; a collector 4 for collecting the air after applied to the object within examination station 2; and an analyzer 5 for analyzing the collected air for the presence of the target substance.

As further shown in FIG. 1, the illustrated apparatus further includes a pre-heater 6 between the blower 3 and the examination station 2 receiving the examined object. Pre-heater pre-heats the air from blower 3 before it is applied to the object within examination station 2. It has been found that pre-heating the air before it is applied to the object more effectively dislodges substances carried by the object for collection within the collector 4 and for analysis within analyzer 5.

Preferably, the pre-heating is at least ten degrees Centigrade above ambient temperature, but within the range of 20-42 degrees Centigrade. Following is a table setting forth preferred air temperature after pre-heating for various ambient temperatures:

| | AIR TEMPERATURE AFTER PRE- |
|---|---|
| AMBIENT TEMPERATURE | HEATING |
| 5° C. | 20° C. |
| 10° C. | 20° C. |
| 15° C. | 25° C. |
| 20° C. | 30° C. |
| 25° C. | 35° C. |
| 30° C. | 40° C. |
| 35° C. | 42° C. |

It has been found that when the air from blower 3 is pre-heated as set forth above, according to the prevailing ambient temperature, the so pre-heated air more effectively dislodges trace substances carried by the person, or other object, thereby substantially increasing the sensitivity of the analysis in analyzer 5 of the air collected in the collector 4.

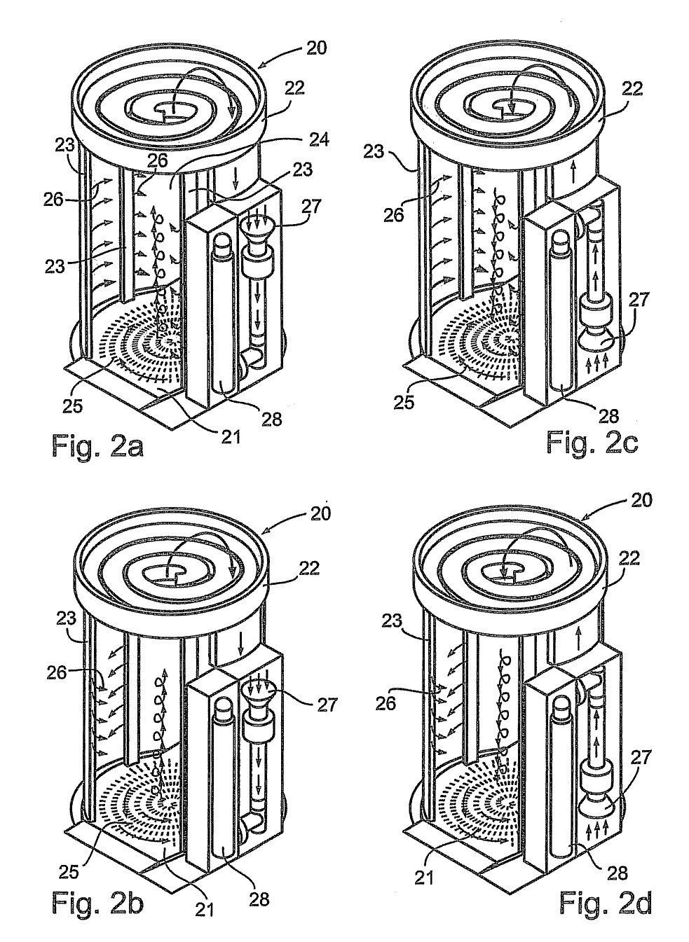

FIGS. 2a-2d illustrate one form of examination station, corresponding to examination station 2 in FIG. 1, for examining a person in order to detect trace amounts of a target substance carried by the person. FIGS. 2a-2d also illustrate various types of air-flow arrangements that may be provided for applying the pre-heated air to the person within the examination station 2.

With reference to FIG. 2a, it will be seen that the examination station, therein generally designated 20, is of generally cylindrical configuration, being dimensioned and configured for receiving a person to be examined. It includes a base 21 for receiving the person in a standing position, a top cover 22 overlying the person, and a cylindrical array of uprights 23, with the spaces 24 between the uprights preferably not covered. If desired, however, the spaces 24 between the cylindrical array of uprights 23 could be covered by a transparent or translucent plastic housing so as not to produce a confined feeling in the person being examined.

The base 21 includes a group of first air nozzles 25, arranged in a plurality of concentric circles, for producing a plurality of air streams directed vertically from the base 21 to the top cover 22. The vertically-extending uprights 23 include a second group of air nozzles 26 for producing another plurality air streams directed horizontally circumferentially of the examination station. As a result, the person within the examination station 20 is subjected to two groups of air streams: a first group of vertically-flowing air streams coaxial around the vertical axis of the examination station from the first group of air nozzles 25 in the base 21; and a second group of circumferentially-flowing horizontal air streams vertically spaced about the vertical axis of the examination station.

The above describes streams of heated air produced by the two groups of nozzles 25, 26 within examination station 20 are effective to dislodge any particles or other substances carried by the object and to entrain such particles or substances within the air flowing to the top cover 22 of examination station 20. The heated air, including the dislodged particles or other substances, is conducted to a collector 27, and is fed therefrom to the analyzer 28, where the collected air is analyzed for the particular target substance, e.g. a concealed explosive, drug, or the like. Analyzer 28 may be of any known type, according to the particular target substance to be detected. Many such analyzers are known as described for example in the above-cited patents, the contents of which are incorporated herein by reference. One preferred example is the chromatograph flash mass spectrometer identified as the Hapsite Smart Chemical Identification System supplied by Inficon Corporation of Syracuse, N.Y., USA.

As seen in FIG. 2a, the horizontally-directed streams of heated air produced by nozzles 26 flow clockwise within examination station 20. Such a flow direction is preferable when the apparatus is used in the southern hemisphere. FIG. 2b illustrates the arrangement wherein the horizontally flowing heated air is in the opposite direction i.e. counter clockwise, which is preferable when the apparatus is used in the northern hemisphere.

In both FIGS. 2a and 2b, the vertically-flowing streams of heated air flow in the upward direction, i.e., from the base 21 towards the upward cover 22. FIGS. 2c and 2d illustrate variations in FIGS. 2a and 2b, respectively, wherein the vertically-flowing streams are in the opposite direction i.e. from the top cover 22 towards the base 21. In all cases the heated air, after applied to the person within the examination station 20, is collected by collector 27 and analyzed in analyzer 28 as described above.

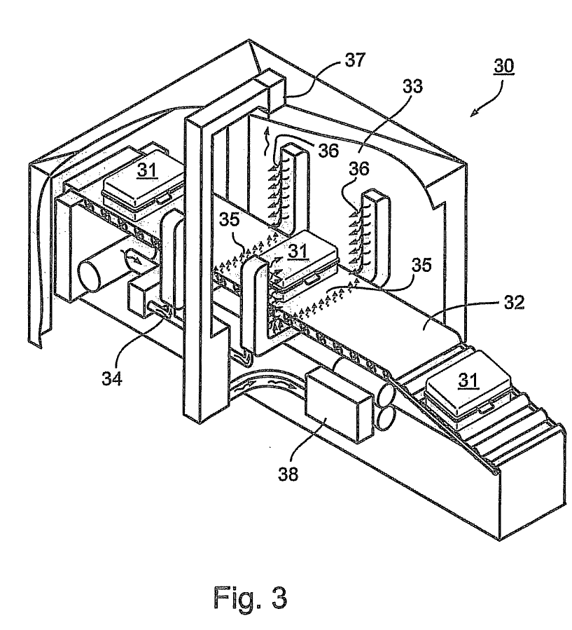

FIG. 3 illustrates the invention embodied in another form of apparatus, generally designated 30, for inspecting luggage 31 fed by a feeding belt 32 through an examination station 33. In this case, the air, pre-heated as described above, is supplied via ducts 34 to a plurality of vertically-oriented air nozzles 35 and a plurality of horizontally-oriented air nozzles 36 within the examination station 33 of the conveyor belt 32, in order to apply heated air to the luggage 31 passing through the examination station 33 and thereby to dislodge substances carried by the luggage. The dislodged substances are collected by a collector 37 and conveyed to an analyzer 38, where the air is analyzed in order to detect the presence of a target substance therein.

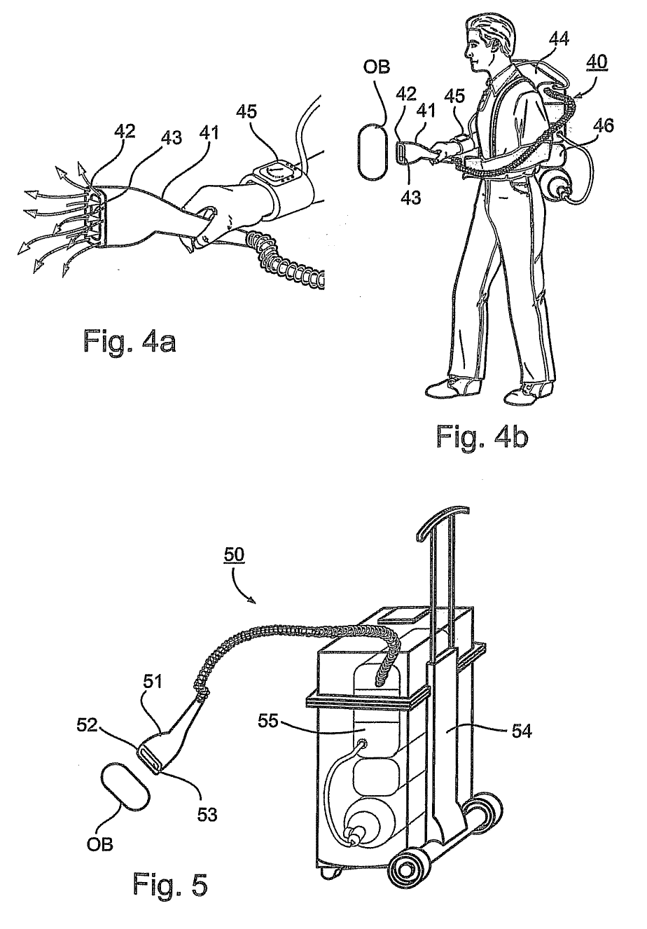

FIGS. 4a and 4b illustrate the invention implemented in apparatus, generally designated 40, included in a backpack for carrying by an individual, and a manually-manipulatable probe 41 for applying the pre-heated air to the person or other object being examined for trace amounts of a target substance. In this case, the air, after being pre-heated by a heater 46 within the backpack 40, is applied via outlet 42 of probe 41, to the object OB being examined, and the heated air, after being so applied, is collected by inlet 43 of the probe and fed to an analyzer 44, also carried by the backpack 40, for the presence of a target substance dislodged from the object by the heated air. The results of the analysis may be fed to a display unit 45 strapped on the wrist of the person carrying the backpack and manipulating the probe 41.

As shown particularly in FIG. 4a, the outlet 42 in the probe for the pre-heated air applied to the object being examined, and the inlet 43 in the probe for collecting the heated air after being applied to the object, are located coaxially with respect to each other, the outlet 42 being located outwardly of and enclosing the inlet 43. It will be appreciated, however, that other suitable arrangement for applying the heated air and collecting it could be provided within the probe 41.

FIG. 5 illustrates apparatus, generally designated 50, constructed in accordance with the present invention implemented in a wheeled cart 54 for easy transportation to any desired inspection site. Apparatus 50 illustrated in FIG. 5 also includes a manually manipulatable probe 51, including an outlet 52 for applying pre-heated to the object OB being examined in order to dislodge particles or other substances carried thereby, and an inlet 53 for collecting the air together with the particles or other substances entrained therein. Probe 51 in FIG. 5 may be of the same construction as probe 41 in FIG. 4a.

It will be appreciated that the portion of apparatus 50 carried by the wheeled cart 54 includes the blower for producing the airflow through outlet 52 of probe 51, the pre-heater for heating the air before discharged through outlet 52, and an analyzer 55 for analyzing the collected air for the presence of the target substance.

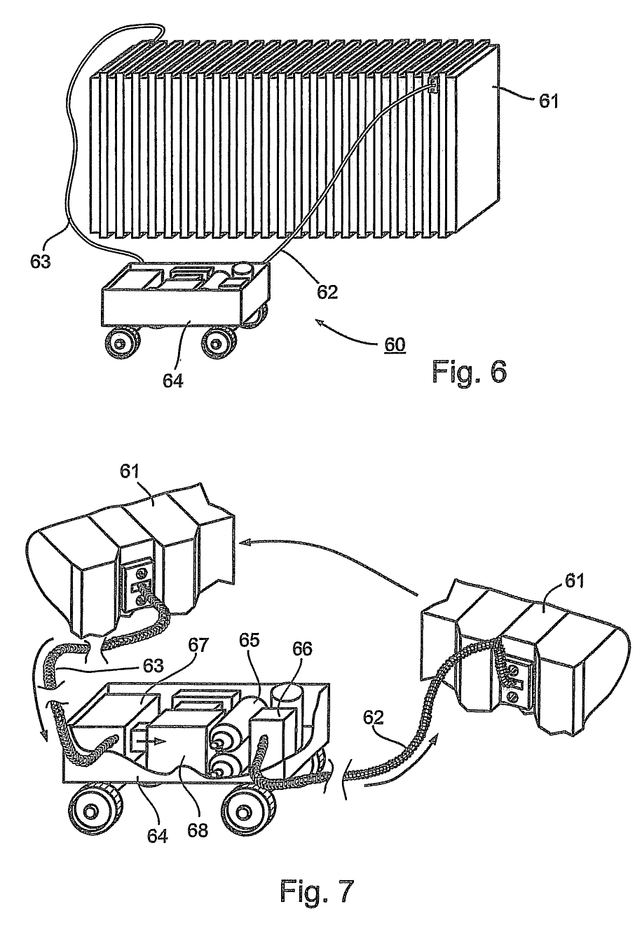

FIG. 6 illustrates the apparatus, therein generally designated 60, also carried by a wheeled cart. In this case, however, the apparatus is used for inspecting a shipping container 61, by applying the pre-heated air via a duct 62 into one end of the container in order to dislodge particles from the goods therein. The pre-heated air, after being applied to the interior of container 61, is collected and outletted via an outlet duct 63 and fed to an analyzer carried by the cart 64 of apparatus 60. It will be appreciated that the illustrated cart includes, not only the analyzer corresponding to analyzer 5 in FIG. 1, but also the blower and pre-heater, corresponding to blower 3 and pre-heater 6 in FIG. 1.

FIG. 7 diagrammatically illustrates more particularly the various components of the cart 60 illustrated in FIG. 6. Thus, as shown FIG. 7, cart 64 includes a blower 65 for producing the flow of air applied to one end of container 61 via a duct 62, and a pre-heater 66 for pre-heating the air before being applied via duct 62 to container 61. Cart 60 further includes a pump 67 for drawing out the air from container 61, together with any dislodged particles or substances entrained within the air, and for feeding such air to an analyzer 68 for analysis of the presence of the target substance.

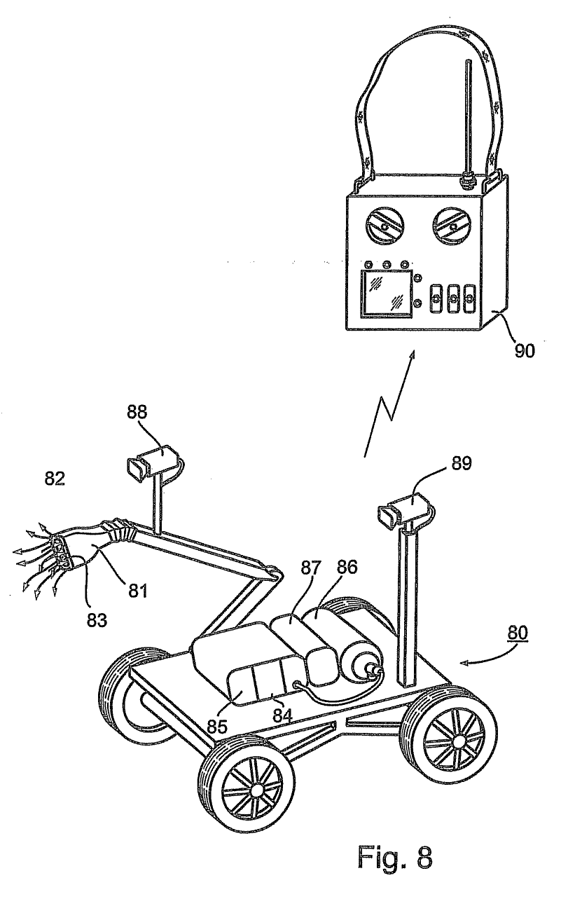

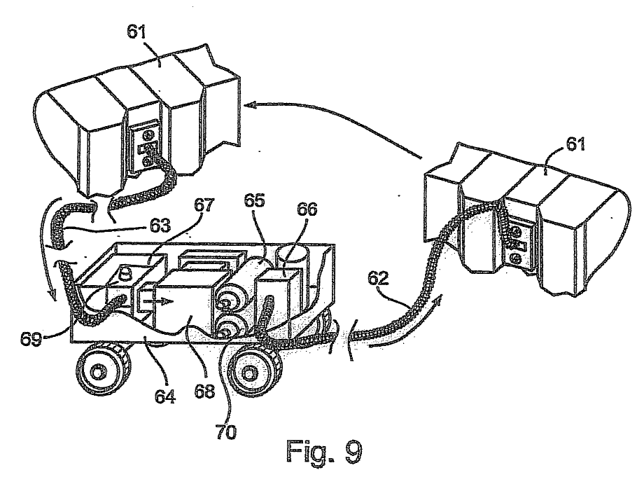

FIG. 8 illustrates the apparatus constructed in accordance with the invention carried by an automotive vehicle 80 to facilitate transporting the apparatus to any desired inspection location. The apparatus illustrated in FIG. 9 also includes a probe 81, which may be of similar construction as probe 41 in FIG. 4a and probe 51 in FIG. 5, to include an outlet 82 for discharging pre-heated air to the object being examined, and an inlet 83 for collecting the air after so applied to the object. Vehicle 80 carries the blower 84 for producing the flow of air via probe 82, and the pre-heater 85 for pre-heating the air as described above. Vehicle 80 further includes a suction pump 86 for drawing the air via inlet 83 and the analyzer 87 which analyzes the collected air for the presence of the target substance.

The apparatus illustrated in FIG. 8 further includes local display unit 88 which displays the results of the analysis analyzer 87, and a wireless transmitter 89 which transmits the results of the analysis to a remotely-located receiver 90 to permit monitoring the results of the examination process at a remote location.

FIG. 9 illustrates an apparatus basically the same as that of FIG. 7, except modified to include an injector 70 for introducing a marker substance into the air before applied to the container. Such a marker substance may be an inert gas, or other substance, such as nitrogen, xenon, etc., or an active substance, such as Freon, which is sensible by analyzer 69. The introduction of such a marker substance into the heated air before applied to the container, and its detection in the air collected from the container, better assures that the gas collected and analyzed is the gas originally introduced. Analyzer 68 does not detect the gas introduced by injector 70, and the injection of the marker substance does not interfere with the analyzer 68 process described hereinabove.

While the invention has been described with respect to several preferred embodiments, it will be appreciated that these are set forth merely for purposes of example, and that many other variations, modifications and applications of the invention may be made.

What is claimed is:

1. A method of examining objects for detecting trace amounts of a target substance carried by the object, comprising:
applying to the object a flow of air which has been pre-heated, to dislodge substances carried by the object;
collecting the heated air after applied to the object;
and analyzing said collected heated air for the presence of said target substance.

2. The method according to claim 1, wherein said air is pre-heated at least ten degrees above ambient, to a temperature within the range of 20-42 degrees Centigrade.

3. The method according to claim 1, wherein said object is located within an examination station, and said heated air is applied both vertically and horizontally within said examination station.

4. The method according to claim 3, wherein said examination station is of a cylindrical configuration, and said heated air applied horizontally within said examination station.

5. The method according to claim 3, wherein said heated air applied vertically is applied at the lower end of the examination station and is collected at the upper end of the examination station.

6. The method according to claim 3, wherein said heated air applied vertically is applied at the upper end of the examination station and is collected at the lower end of the examination station.

7. The method according to claim 3, wherein said examination station is dimensioned and configured for receiving persons as the objects to be examined.

8. The method according to claim 3, wherein said examination station is dimensioned and configured for receiving baggage to be conveyed therethrough by a conveyer.

9. The method according to claim 1, wherein said object is a container, and said heated air is applied to one end of said container and collected from the opposite end of the container.

10. The method according to claim 1, wherein a marker substance is introduced into the air before applied to the object, and the collected heated air is analyzed also for the presence of said marker substance/

11. A method of examining objects within an examination station for detecting tracer amounts of target substance carried by the object, comprising:
applying air both vertically and horizontally within the examination station to dislodge from the object substances carried by the object;
collecting the air after applied to the object;
and analyzing said collected air for the presence of said target substance.

12. The method according to claim 11, wherein said examination station is of a cylindrical configuration, and said air applied horizontally within said examination station is applied circumferentially of the examination station.

13. The method according to claim 11, wherein said air applied vertically is applied at the lower end of the examination station and is collected at the upper end of the examination station.

14. The method according to claim 11, wherein said air applied vertically is applied at the upper end of the examination station, and is collected at the lower end of the examination station.

15. The method according to claim 11, wherein said air, before applied though the examination station, is heated to a temperature at least ten degrees Centigrade above ambient but within the range of 20-42 degrees Centigrade.

16. Apparatus for examining objects for detecting trace amounts of a target substance carried by the object, comprising:
a source of pressurized air for applying a flow of air to the object in order to dislodge substances therefrom;
a heater for heating the air before applied to the object;
a collector for collecting the air after applied to the object;
and an analyzer for analyzing the collected air for the presence of said target substance.

17. The apparatus according to claim 16, wherein said heater heats the air to a temperature of at least ten degrees Centigrade above ambient but within the range of 20-42 degree Centigrade.

18. The apparatus according to claim 16, wherein said apparatus further comprises an examination station for receiving the objects to be examined;
a first group of air nozzles located for applying said air vertically through the examination station;
and a second group of air nozzles located for applying said air horizontally within the examination station.

19. The apparatus according to claim 18, wherein said examination station is of a cylindrical configuration, and said second group of nozzles are orientated to apply said heated air circumferentially within the examination station.

20. The apparatus according to claim 18, wherein said first group of air nozzles are located to apply the heated air into the lower end of the examination station, and said collector is located to collect the air from the upper end of the examination station.

21. The apparatus according to claim 18, wherein said first group of air nozzles are located to apply the heated air into the upper end of the examination station, and said collector is located to collect the air from the lower end of the examination station.

22. The apparatus according to claim 18, wherein said examination station is dimensioned and configured for receiving persons as the object to be examined.

23. The apparatus according to claim 18, wherein said examination station is dimensioned and configured for receiving baggage to be conveyed therethrough by a conveyer.

24. The apparatus according to claim 16, wherein said object is a container, and said heated air is applied to one end of said container and collected from the opposite end of the container.

25. The apparatus according to claim 16, wherein said apparatus further comprises a manually-manipulatable probe having an outlet for applying said heated air to the object, and an inlet for collecting the heated air after applied to the object.

26. The apparatus according to claim 25 wherein said outlet and inlet are coaxially located within said probe.

27. The apparatus according to claim 26 wherein said outlet is located outwardly of said inlet.

28. The apparatus according to claim 16, wherein said source of pressurized air, heater, collector and analyzer are included in a backpack designed and dimensioned for carrying by an individual.

29. The apparatus according to claim 16, wherein said source of pressurized air, heater, collector and analyzer are included in a wheeled cart for conveying to a desired location.

30. The apparatus according to claim 16, wherein said apparatus further comprises a wireless transmitter for transmitting to a remote location information regarding the results produced by said analyzer.

31. The apparatus according to claim 16, wherein said apparatus further comprises an injector for introducing a marker substance into the air before applied to the object; and wherein said analyzer analyzes said collected air also for the presence of said marker substance.

32. Apparatus for examining objects in order to detect trace amounts of a target substance carried by the objects, comprising:
an examination station sized and dimensioned for receiving an object to be examined;
a first group of nozzles for applying a flow of air vertically through the examination station in order to dislodge substances from the object;
a second group of nozzles for applying a flow of air horizontally within the examination station in order to dislodge substances from the object;
a collector for collecting the air after applied to the object;
and an analyzer for analyzing the collected air for the presence of said target substance.

33. The apparatus according to claim 32, wherein said examination station is of a cylindrical configuration, and said second group of nozzles are orientated to apply said air circumferentially of the examination station.

34. The apparatus according to claim 32, wherein said first group of air nozzles are located to apply the air into the lower end of the examination station, and said collector is located to collect the air from the upper end of the examination station.

35. The apparatus according to claim 32, wherein said first group of air nozzles are located to apply the air into the upper end of the examination station, and said collector is located to collect the air from the lower end of the examination station.

36. The apparatus according to claim 32, wherein said examination station is dimensioned and configured for receiving persons as the objects to be examined.

37. The apparatus according to claim 36, wherein said examination station comprises:
a base for receiving the person to be examined;
a top cover overlying and vertically spaced from the base;
a circular array of vertically-extending uprights mounting the top cover vertically over said base;
a first plurality of air nozzles at one end of the examination station for directing a plurality of air streams in the vertical direction through the examination station;
a second plurality of air nozzles carried by said vertically-extending uprights for directing a plurality of air streams in the horizontal direction circumferentially of the examination station;
and an exhaust opening at the opposite end of said examination station for collecting air after applied to the person within said examination station.

38. The apparatus according to claim 37, wherein said circular array of vertically-extending uprights are enclosed by a cylindrical housing.

39. The apparatus according to claim 37, wherein said first plurality of air nozzles are arrayed in concentric circles; and said second plurality of air nozzles are also arrayed in concentric circles.

40. The apparatus according to claim 32, wherein said examination station is dimensioned and configured for receiving baggage conveyed through by a conveyer.

41. The apparatus according to claim 32, wherein said apparatus further comprises a heater for heating the air before applied to the examination station to a temperature at least ten degrees Centigrade above ambient, but within the range of 20-42 degrees Centigrade.

42. Apparatus for examining objects for detecting trace amounts of a target substance carried by the object, comprising;
a source of pressurized air for applying a flow of air to the object in order to dislodge substances therefrom;
a manually-maniputable probe having an outlet for applying said pressurized air to the objects, and an inlet for collecting the air after applied to the object;
and an analyzer for analyzing the collected air for the presence of said target substance.

43. The apparatus according to claim 42 wherein said outlet and inlet are coaxially located within said probe.

44. The apparatus according to claim 43 wherein said outlet is located outwardly of said inlet.

45. The apparatus according to claim 42, wherein said source of pressurized air, probe and analyzer are included in a backpack designed and dimensioned for carrying by an individual.

46. The apparatus according to claim 42, wherein said source of pressurized air, probe and analyzer are included in a wheeled cart for conveying to a desired location.

47. The apparatus according to claim 42, wherein said apparatus further comprises a heater for heating the air before applied to the object in the examination station to a temperature at least ten degrees Centigrade above ambient, but within the range of 20-42 degrees Centigrade.
